(19) United States
(12) Patent Application Publication
(10) Pub. No.: US 2016/0333223 A1
(43) Pub. Date: Nov. 17, 2016

(54) SELF-WETTING ADHESIVE EMULSION COMPOSITION

(71) Applicant: 3M INNOVATIVE PROPERTIES COMPANY, St. Paul, MN (US)

(72) Inventors: Lili Qie, Woodbury, MN (US); Ann R. Fornof, Austin, TX (US); James P. DiZio, St. Paul, MN (US)

(21) Appl. No.: 15/111,509

(22) PCT Filed: Jan. 9, 2015
(86) PCT No.: PCT/US2015/010732

§ 371 Date: Jul. 14, 2016

Related U.S. Application Data
(60) Provisional application No. 61/928,533, filed on Jan. 17, 2014.

(51) Int. Cl. C09J 4/06; B32B 7/12; C08F 220/18

(52) U.S. Cl. CPC C09J 4/06; C08F 220/18; B32B 7/12; B32B 2307/412; B32B 2255/00; B32B 2405/00

(57) ABSTRACT

A polymerizable emulsion compositions comprising an oil phase having a (meth)acrylate copolymer, a plasticizer, a non-reactive (meth)acrylate copolymeric stabilizer; and a continuous aqueous phase comprising a buffer, non-polymerizable surfactant; and an oil- or water soluble initiator is described.

### BACKGROUND

Pressure-sensitive tapes are virtually ubiquitous in the home and workplace. In its simplest configuration, a pressure-sensitive tape comprises an adhesive and a backing, and the overall construction is tacky at the use temperature and adheres to a variety of substrates using only moderate pressure to form the bond. In this fashion, pressure-sensitive tapes constitute a complete, self-contained bonding system.

According to the Pressure-Sensitive Tape Council, adhesives are known to possess properties including the following: (1) adherence with no more than finger pressure, (2) sufficient ability to hold onto an adherend, and (3) sufficient cohesive strength to be removed cleanly from the adherend. Materials that have been found to function well as adhesives include polymers designed and formulated to exhibit the requisite viscoelastic properties resulting in a desired balance of tack, peel adhesion, and shear holding power.

These requirements are assessed generally by means of tests which are designed to individually measure tack, adhesion (peel strength), and cohesion (shear holding power), as noted in A. V. Pocius in Adhesion and Adhesives Technology: An Introduction, 2^{nd} Ed., Hanser Gardner Publication, Cincinnati, Ohio, 2002. These measurements taken together constitute the balance of properties often used to characterize an adhesive.

Various methods of suspension or emulsion polymerization for copolymer pressure-sensitive adhesives have been disclosed in the art. Emulsion polymerization uses water as the reaction medium, and the polymerization takes place within a micelle which easily dissipates the exotherm due to heat of polymerization. Because water is the solvent, the resulting emulsion is safer to handle.

While emulsion polymerization has these distinct advantages, the energy required to dry the water from coated latex materials is about five times higher than for most solvents. Also, the water portion of a dilute latex constitutes a large amount of excess storage capacity and shipping weight when handling emulsion polymers. Thus, there is considerable interest in producing so-called “high-solids” latexes to alleviate some of these problems. Unfortunately, in many cases achieving high solids also meant achieving high viscosities, so that coating the latexes was difficult and expensive.

Thus, there is ongoing interest in producing a high-solids latex adhesive with low viscosity in order to reduce shipping, handling and storage costs, allow increased productivity in plant equipment, reduce drying time for applied latexes, allow the application of films of any desired thickness in fewer passes, and save energy in the drying of latex coatings. Latex refers to an aqueous suspension or emulsion of a polymer, more specifically it refers to an aqueous emulsion of the polymers produced by polymerization of the emulsions described herein.

### SUMMARY

The present disclosure provides a polymerizable emulsion compositions comprising an oil phase having a (meth)acrylate copolymer, a plasticizer, a non-reactive (meth)acrylate copolymeric stabilizer; and a continuous aqueous phase comprising a buffer, non-polymerizable surfactant; and an oil- or water soluble initiator. When polymerized, the resulting emulsion may be coated on a substrate and dried to provide a self-wetting adhesive. The present disclosure further relates to a water-based, high-solids moisture-resistant latex pressure sensitive adhesive.

The adhesives of this disclosure provide the desired balance of tack, peel adhesion, and shear holding power, and further conform to the Dahlquist criteria; i.e. the modulus of the adhesive at the application temperature, typically room temperature, is less than 3×10⁶ dynes/cm at a frequency of 1 Hz.

The cured adhesive composition, when cured, exhibits low peel strength and is self-wetting. By “self-wetting” is meant that the cured adhesive formulation exhibits spontaneous wetting out on a smooth surface to which it is applied with little or no external pressure. An additional characteristic of a self-wetting adhesive formulation is that the cured adhesive is removable with little or no residue remaining on the surface to which it had been applied. The initial 180° peel strength of the cured formulation is less than about 5 N/dm and in some cases less than about 1 N/dm.

The adhesive compositions, when cured, are non-yellowing, exhibits low shrinkage, low birefringence and low sensitivity to moisture (cloud point-resistant), making it suitable for many optical applications including, but not limited to bonding polarizers to modules of a liquid crystal display (LCD) and attaching various optical films to a glass lens in, for example, mobile hand held (MHH) devices.

In some embodiments the adhesives adhere, yet remain repeatedly peelable from a variety of smooth substrates such as glass, metal, wood, paper with matte or glossy finish surfaces or polymer substrates over a long period of time without damaging the substrate or leaving any adhesive residue or stain on the surface. Adhesive articles are provided comprising a flexible backing such as, for example, a biaxially-oriented polyethylene terephthalate.

Ideally, depending on the substrate, the removable adhesive must provide wettability to the substrate and quick initial adhesion (sufficient initial tack or quick stick) to quickly fix the adhesive to the desired substrate. On the other hand, the adhesive should exhibit only a low and at any rate acceptable adhesion buildup with time, even at elevated temperatures, to ensure clean peelability after a prolonged dwell. The adhesive should furthermore be characterized by an adequate peel strength to give a reliable, high performance adhesion to the substrate without damaging the substrate when removing the adhesive. The adhesives exhibit sufficient cohesive and tensile strength and dimensional stability of the adhesive article to allow proper handling and, in particular, the reapplication of the article to substrate after having peeled it off once or several times. A sufficient cohesive strength is also desirable in order to limit the cold flow of the adhesive on a surface, a process which leads to an undesirable build-up of peel strength over time. The static shear strength should be high enough to allow light-duty mounting applications without being too high to result in permanent adhesion. In some embodiments the adhesive should furthermore exhibit a high resistivity against water in order to allow outdoor applications. Furthermore, a high resistance against organic solvents is desirable.

In some embodiments the adhesives are transparent to visible light in order to allow for an essentially invisible mounting of objects on transparent substrates such as glass or transparent polymers. The present disclose provides an optically clear adhesive article that includes an optically clear substrate and the cured optical adhesive composition disposed on a major surface of the substrate. This disclosure further provides an optically clear article comprise a first and second optical clear substrate, and the cured adhesive disposed between the two substrates. The articles of the disclosure may have a thickness greater than about 0.03 millimeters, generally a birefringence (absolute) of less than 1×10⁶, light transmission greater than about 85% (over the spectral region of interest), preferably greater than 90%, more preferably greater than 95%, and a CIELAB b* less than about 1.5 units, preferably less than about 1.0 unit for samples with adhesive thickness of 500 microns. The visible range of 400-700 nanometers is of particular interest.

Exemplary formulations can also easily be removed, so that when used for screen protection for example, a film covering can be removed, should a consumer desire to do so or if other circumstances warrant, without damaging the screen or leaving behind a residue. Exemplary formulations also exhibit a low peel strength upon curing resulting in an adhesive that is easily removable.

### DETAILED DESCRIPTION

The monomer component of the oil phase comprises a monomeric (meth)acrylic ester of a non-tertiary alcohol, which alcohol contains from 1 to 18 carbon atoms and preferably an average of from 4 to 12 carbon atoms. A mixture of such monomers may be used.

Examples of monomers suitable for use as the (meth)acrylate ester monomer include the esters of either acrylic acid or methacrylic acid with non-tertiary alcohols such as ethanol, 1-propanol, 2-propanol, 1-butanol, 2-butanol, 1-pentanol, 2-pentanol, 3-pentanol, 2-methyl-1-butanol, 3-methyl-1-butanol, 1-hexanol, 2-hexanol, 2-methyl-1-pentanol, 3-methyl-1-pentanol, 2-ethyl-1-butanol, 3,5,5-trimethyl-1-hexanol, 3-heptanol, 1-octanol, 2-octanol, isooctylalcohol, 2-ethyl-1-hexanol, 1-decanol, 2-propylheptanol, 1-dodecanol, 1-tridecanol, 1-tetradecanol, citronellol, dihydrocitronellol, and the like. In some embodiments, the preferred (meth)acrylate ester monomer is the ester of (meth)acrylic acid with butyl alcohol or isooctyl alcohol, or a combination thereof, although combinations of two or more different (meth)acrylate ester monomer are suitable.

In some embodiments, the preferred (meth)acrylate ester monomer is the ester of (meth)acrylic acid with an alcohol derived from a renewable source, such as 2-octanol, citronellol, dihydrocitronellol.

In some embodiments a portion of the above described (meth)acrylate esters may be substituted with (meth)acrylates derived from 2-alkyl alkanols (Guerbet alcohols) as described in U.S. Pat. No. 8,137,807 (Lewandowski et al.), incorporated herein by reference.

The (meth)acrylate ester monomer is present in an amount of 80 to 99 parts by weight based on 100 parts total monomer content in the monomer mixture. Preferably (meth)acrylate ester monomer is present in an amount of 95 to 99 parts by weight based on 100 parts total monomer content.

The monomer component of the oil phase further comprises an optional acid functional monomer, where the acid functional group may be an acid per se, such as a carboxylic acid, or a portion may be salt thereof, such as an alkali metal carboxylate. Useful acid functional monomers include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, oleic acid, β-carboxyethyl (meth)acrylate, 2-sulfoethyl methacrylate, styrene sulfonic acid, 2-acrylamido-2-methylpropanesulfonic acid, vinylphosphonic acid, and mixtures thereof.

Due to their availability, acid functional monomers of the acid functional copolymer are generally selected from ethylenically unsaturated carboxylic acids, i.e. (meth)acrylic acids. When even stronger acids are desired, acidic monomers include the ethylenically unsaturated sulfonic acids and ethylenically unsaturated phosphonic acids. The acid functional monomeris generally used in amounts of 1 to 15 parts by weight, preferably 1 to 5 parts, based on 100 parts by weight total monomer in the monomer mixture.

In addition to the acrylic ester monomer and acid functional monomer, the copolymer may optionally include other monomers, such as non-acid functional polar monomers, vinyl monomers and vinyl ether monomers, provided the resultant copolymer maintains the compatibility with the plasticizer, and has the requisite optical and adhesive properties. Such additional monomers may be used in amounts of up to 10 parts by weight, preferably 1 to 5 parts, relative to 100 parts by weight of total monomers.

Representative examples of suitable polar monomers include but are not limited to 2-hydroxyethyl (meth)acrylate; N-vinylpyrrolidone; N-vinylcaprolactam; acrylamide; mono- or di-N-alkyl substituted acrylamide; t-butyl acrylamide; dimethylaminoethyl acrylamide; N-octyl acrylamide; poly(alkoxyalkyl) (meth)acrylates including 2-(2-ethoxyethoxy)ethyl (meth)acrylate, 2-ethoxyethyl (meth)acrylate, 2-methoxyethoxyethyl (meth)acrylate, 2-methoxyethyl methacrylate, polyethylene glycol mono(meth)acrylates; alkyl vinyl ethers, including vinyl methyl ether; and mixtures thereof. Preferred polar monomers include those selected from the group consisting of polyethylene glycol mono(meth)acrylates, 2-hydroxyethyl (meth)acrylate and N-vinylpyrrolidinone.

In order to provide sufficient cohesive strength of the adhesive composition, a multifunctional (meth)acrylate is incorporated into the blend of polymerizable monomers. A multifunctional (meth)acrylate, when used in the amounts described herein provide an adhesive having low tack, high shear modulus, low peel, and facilitates the self-wetting property. Examples of useful multifunctional (meth)acrylate include, but are not limited to, di(meth)acrylates, tri(meth)acrylates, and tetra(meth)acrylates, such as 1,6-hexanediol di(meth)acrylate, poly(ethylene glycol) di(meth)acrylates, polybutadiene di(meth)acrylate, polyurethane di(meth)acrylates, and propoxylated glycerin tri(meth)acrylate, and mixtures thereof. The amount and identity of multifunctional (meth)acrylate is tailored depending upon application of the adhesive composition.

Typically, the multifunctional (meth)acrylate is present in amounts less than 5 parts based on 100 parts of the monomer component. More specifically, the multifunctional (meth)acrylate may be present in amounts from 1 to 5 parts based on 100 parts of the monomer component. In some embodiments, no multifunctional (meth)acrylates are present in the monomer mixture.

The adhesive composition further comprises a plasticizer that acts to increase flexibility of the cured adhesive film by internal modification (i.e., solvation) of the polymeric film and enhances the self-wetting properties. The plasticizer may be solid or liquid at room temperature. If solid, the plasticizer can be softened or liquefied by heating to cause the plasticizer to melt.

If solid, the plasticizer is typically a crystalline solid, displaying a measurable melting temperature when measured using Differential Scanning Calorimetry (DSC). It is preferred that the melting temperature of solid plasticizers used in the present invention is relatively low (i.e., less than about 60° C. so as to minimize any heating that may be required. Preferably, however, the plasticizer is liquid at room temperature so that an elevated temperature step is not necessary. When plasticizers are used that are liquid at room temperature, heating is not required to cause the bond to form in a timely manner.

Viscosity of the plasticizer may be tailored for application. It is preferred that the viscosity of the plasticizer is sufficiently low to facilitate spreading of compounded adhesive over the substrate surface. Preferably, viscosity of the plasticizer is less than about 1,000 centiPoise (cP) when liquefied, more preferably, the viscosity of the plasticizer is less than about 500 cP, and most preferably, less than about 200 cP when liquefied.

It is preferred that the plasticizer is compatible with the polymeric film. When the polymeric film is a blend of more than one polymer, it is preferred that the plasticizer is compatible with each polymer in the blend. Compatibility of the plasticizer with the polymeric film helps to minimize the amount of time needed for bond formation. Furthermore, compatibility of the plasticizer with the polymeric film enhances long term effectiveness of the bond with the substrate.

“Compatible” refers to a plasticizer that: (1) visually exhibits essentially no gross phase that would deleteriously alter the desired optical properties or leave a residue upon peeling from a substrate. Some migration of the plasticizer from or throughout the polymeric film can be tolerated, such as minor separation due to composition equilibrium or temperature influences, but the plasticizer does not migrate to the extent of phase separation between the cured adhesive copolymer and plasticizer. Haziness may also be evidence of gross phase separation.

It is also preferred that the plasticizer is non-volatile. “Non-volatile” refers to plasticizers that do not substantially vaporize under bond formation conditions. That is, the plasticizers generate less than 3% VOC (volatile organic content). The VOC content can be determined analogously to ASTM D 5403-93 by exposing the plasticizer compounded adhesive to 100° C. in a forced draft oven for one hour. If less than 3% of the plasticizer is lost from the compounded adhesive, then the plasticizer is considered “non-volatile.”

Preferably, the plasticizer is non-reactive with other components of the adhesive or air. For example, preferably the plasticizer is inert with respect to other components in the system, including the adhesive (co)polymer and substrate. When the plasticizer is non-reactive with respect to air, loss of optical properties, such as by hazing or yellowing, may be minimized.

Useful plasticizers have a broad range of molecular weights and architectures. The plasticizers may be polymeric or monomeric. Small molecule plasticizers are typically derived from mono- or multi-functional, low molecular weight acids or alcohols that are esterified with a mono-functional alcohol or mono-functional acid, respectively. Common among these monomeric plasticizers are esters of mono- or di-basic acids such as myristate esters, phthalate esters, adipate esters, phosphate esters, citrates, trimellitates, glutarates, and sebacate esters (e.g., dialkyl phthalates, such as dibutyl phthalate, diisoctyl phthalate, dibutyl adipate, dioctyl adipate; 2-cthylhexyl diphenyl diphosphatc; t-butylphenyl diphenyl phosphate; butyl benzylphthalates; dibutoxyethoxyethyl adipate; dibutoxypropoxypropyl adipate; acetyltri-n-butyl citrate; dibutylsebacate; etc.). Phosphate ester plasticizers are commercially sold under the trade designation SANTICIZER from Monsanto; St. Louis, Mo. Glutarate plasticizers are commercially sold under the trade designation PLASTHALL 7050 from C. P. Hall Co.; Chicago, Ill.

Preferably, the plasticizer is selected from the group consisting of monoalkyl esters of aliphatic carboxylic acids, monoalkyl esters of aromatic carboxylic acids, polyalkyl esters of aliphatic carboxylic acids, polyalkyl esters of aromatic carboxylic acids, polyalkyl esters of aliphatic alcohols, polyalkyl esters of phosphonic acids, poly(alkoxylated) esters of aliphatic carboxylic acids, poly(alkoxylated) esters of aromatic carboxylic acids, poly(alkoxylated) ethers of aliphatic alcohols, poly(alkoxylated) ethers of phenols, and mixtures thereof. In some preferred embodiments the esters are derived from an alcohol from a renewable source, such as 2-octanol, citronellol, dihydrocitronellol or from 2-alkyl alkanols (Guerbet alcohols) as described in U.S. Pat. No. 8,137,807 (Lewandowski et al.), incorporated herein by reference.

The amount of plasticizer used depends on the materials comprising the substrates and polymeric film, as well as their dimensions. Generally, the amount of plasticizer used is greater than 20 parts by weight, relative to 100 parts by weight of the monomer component. Preferably the amount of plasticizer is from 20 to 50 parts by weight relative to 100 parts by weight of the monomer component, or relative to cured acrylic copolymer to provide useful bonding times and faster wet-out of a substrate.

The oil phase further comprises a hydrophobic, non-polymerizable (meth)acrylate stabilizer which enhances the emulsion stability during polymerization by inhibiting monomer diffusion from smaller droplets to larger droplets and absorbing more surfactant to the surface of the monomer droplets and improving compliance of the resultant PSA; and polymerization in the presence of an ionic surfactant which improves cohesive strength and imparts moisture resistance.

The term “hydrophobic polymer” as used herein refers to a water insoluble polymer. Useful hydrophobic polymers should have a molecular weight larger than 400; preferably about 750-700,000. If the hydrophobic polymer had a molecular weight of less than 400, the hydrophobic polymer would act as a plasticizer. Useful hydrophobic stabilizers are (meth)acrylate (co)polymers comprising:

90-99 wt. % (meth)acrylate esters, 0-5 wt. % acid functional monomers and 0-5 wt. % other non-acid-functional polar monomers, each described supra. As both the acid functional monomers and non-acid-functional polar monomers increase the hydrophilicity, it is preferred the total be 10 wt. %, preferably 5 wt. % of less, most preferably 1 to 5 wt. %.

In some embodiments, the hydrophobic stabilizer comprises polymerized monomer units of high T_{g} monomers. As used herein the term “high T_{g} monomer” refers to a monomer, which when homopolymerized, produce a (meth)acrylate copolymer having a T_{g} of ≧50° C. The incorporation of the high T_{g} monomer to the high T_{g} copolymer is sufficient to raise the glass transition temperature of the resulting copolymer to ≧20° C., preferably ≧30° C., as calculated using the Fox Equation. Alternatively, the glass transition temperature can be measured in a variety of known ways, including, e.g., through differential scanning calorimetry (DSC). That is, the copolymer comprises a mixture of both high- and low-T_{g} (meth)acrylate ester monomers such that the desired T_{g} is achieved.

Suitable high T_{g} monomers include, but are not limited to, t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl methacrylate, isobornyl acrylate, isobornyl methacrylate, benzyl methacrylate, 3,3,5 trimethylcyclohexyl acrylate, cyclohexyl acrylate, N-octyl acrylamide, and propyl methacrylate or combinations.

The hydrophobic polymeric stabilizer can be prepared by techniques including, but not limited to, the conventional techniques of solvent polymerization, dispersion polymerization, and solventless bulk polymerization. The monomer mixture may comprise a polymerization initiator, especially a thermal initiator or a photoinitiator of a type and in an amount effective to polymerize the co-monomers.

A typical solution polymerization method is carried out by adding the monomers, a suitable solvent, and an optional chain transfer agent to a reaction vessel, adding a free radical initiator, purging with nitrogen, and maintaining the reaction vessel at an elevated temperature, typically in the range of about 40 to 100° C. until the reaction is completed, typically in about 1 to 20 hours, depending upon the batch size and temperature. Examples of the solvent are methanol, tetrahydrofuran, ethanol, isopropanol, acetone, methyl ethyl ketone, methyl acetate, ethyl acetate, toluene, xylene, and an ethylene glycol alkyl ether. Those solvents can be used alone or as mixtures thereof.

Water-soluble and oil-soluble initiators useful in preparing the hydrophobic polymer stabilizer used in the present invention are initiators that, on exposure to heat, generate free-radicals which initiate (co)polymerization of the monomer mixture. Water-soluble initiators are preferred for preparing the (meth)acrylate polymers by emulsion polymerization. Suitable water-soluble initiators include but are not limited to those selected from the group consisting of potassium persulfate, ammonium persulfate, sodium persulfate, and mixtures thereof; oxidation-reduction initiators such as the reaction product of the above-mentioned persulfates and reducing agents such as those selected from the group consisting of sodium metabisulfite and sodium bisulfite; and 4,4′-azobis(4-cyanopentanoic acid) and its soluble salts (e.g., sodium, potassium). The preferred water-soluble initiator is potassium persulfate. Suitable oil-soluble initiators include but are not limited to those selected from the group consisting of azo compounds such as VAZO™ 64 (2,2′-azobis(isobutyronitrile)) and VAZO™ 52 (2,2′-azobis(2,4-dimethylpentanenitrile)), both available from E.I. du Pont de Nemours Co., peroxides such as benzoyl peroxide and lauroyl peroxide, and mixtures thereof. The preferred oil-soluble thermal initiator is (2,2′-azobis(isobutyronitrile)). When used, initiators may comprise from about 0.05 to about 1 part by weight, preferably about 0.1 to about 0.5 part by weight based on 100 parts by weight of monomer components in the pressure-sensitive adhesive.

In a typical photopolymerization method, a monomer mixture may be irradiated with ultraviolet (UV) rays in the presence of a photopolymerization initiator (i.e., photoinitiators). Useful photoinitiators include benzoin ethers such as benzoin methyl ether and benzoin isopropyl ether; substituted acetophenones such as 2,2-dimethoxyacetophenone, available as Irgacure™ 651 photoinitiator (BASF, Ludwigshafen, Germany), 2,2 dimethoxy-2-phenyl-1-phenylethanone, available as Esacure™ KB-1 photoinitiator (Sartomer Co.; West Chester, Pa.), and dimethoxyhydroxyacetophenone; substituted α-ketols such as 2-methyl-2-hydroxy propiophenone; aromatic sulfonyl chlorides such as 2-naphthalene-sulfonyl chloride; and photoactive oximes such as 1-phenyl-1,2-propanedione-2-(O-ethoxy-carbonyl)oxime. Particularly preferred among these are the substituted acetophenones.

Preferred photoinitiators are photoactive compounds that undergo a Norrish I cleavage to generate free radicals that can initiate by addition to the acrylic double bonds. Additional photoinitiator can be added to the mixture to be coated after the copolymer has been formed.

The polymerizable composition and the photoinitiator may be irradiated with activating UV radiation to polymerize the monomer component(s) to produce the hydrophobic polymer stabilizer. UV light sources can be of two types: 1) relatively low light intensity sources such as backlights which provide generally 10 mW/cm² or less (as measured in accordance with procedures approved by the United States National Institute of Standards and Technology as, for example, with a Uvimap™ UM 365 L-S radiometer manufactured by Electronic Instrumentation & Technology, Inc., in Sterling, Va.) over a wavelength range of 280 to 400 nanometers and 2) relatively high light intensity sources such as medium pressure mercury lamps which provide intensities generally greater than 10 mW/cm², preferably between 15 and 450 mW/cm². For example, an intensity of 600 mW/cm² and an exposure time of about 1 second may be used successfully. Intensities can range from about 0.1 to about 150 mW/cm², preferably from about 0.5 to about 100 mW/cm², and more preferably from about 0.5 to about 50 mW/cm². Such photoinitiators preferably are present in an amount of from 0.1 to 1.0 pbw per 100 pbw of the polymer composition.

The degree of conversion (of monomers to copolymer) can be monitored during the irradiation by measuring the index of refraction of the polymerizing mixture.

Solventless polymerization methods, such as the continuous free radical polymerization method described in U.S. Pat. Nos. 4,619,979 and 4,843,134 (Kotnour et al.); the essentially adiabatic polymerization methods using a batch reactor described in U.S. Pat. No. 5,637,646 (Ellis); and, the methods described for polymerizing packaged pre-adhesive compositions described in U.S. Pat. No. 5,804,610 (Hamer et al.) may also be utilized to prepare the polymers. Preferably, the hydrophobic polymer stabilizer is prepared by the adiabatic batch polymerization process wherein the total of the absolute value of any energy exchanged to or from the batch during the course of reaction will be less than about 15% of the total energy liberated due to reaction for the corresponding amount of polymerization that has occurred during the time that polymerization has occurred, as described in U.S. Pat. No. 5,637,646 (Ellis), incorporated herein by reference.

It will be understood that the polymerization method to produce the hydrophobic polymer stabilizer will produce a “dead polymer” in the initial free radical polymerization; i.e. a fully polymerized, not free-radically polymerizable polymer. Subsequently the monomer mixture for the low T_{g} copolymers do not free-radically polymerize monomers in the emulsion, although the two copolymers may be subsequently crosslinked.

The continuous aqueous phase comprises a surfactant. Useful surfactants for the present invention include those selected from the group consisting of anionic surfactants, cationic surfactants, nonionic surfactants, and mixtures thereof.

Useful anionic surfactants include but are not limited to those whose molecular structure includes at least one hydrophobic moiety selected from the group consisting of from about C₆- to C₁₂-alkyl, alkylaryl, and/or alkenyl groups as well as at least one anionic group selected from the group consisting of sulfate, sulfonate, phosphate, polyoxyethylene sulfate, polyoxyethylene sulfonate, polyoxyethylene phosphate, and the like, and the salts of such anionic groups, wherein said salts are selected from the group consisting of alkali metal salts, ammonium salts, tertiary amino salts, and the like. Representative commercial examples of useful anionic surfactants include sodium lauryl sulfate, available from Stepan Chemical Co. as POLYSTEP B-3; sodium lauryl ether sulfate, available from Stepan Chemical Co. as POLYSTEP B-12; and sodium dodecyl benzene sulfonate, available from Rhone-Poulenc as SIPONATE DS-10.

Useful nonionic surfactants include but are not limited to those whose molecular structure comprises a condensation product of an organic aliphatic or alkyl aromatic hydrophobic moiety with a hydrophilic alkylene oxide such as ethylene oxide. The HLB (Hydrophilic-Lipophilic Balance) of useful nonionic surfactants is about 10 or greater, preferably from about 10 to about 20. The HLB of a surfactant is an expression of the balance of the size and strength of the hydrophilic (water-loving or polar) groups and the lipophilic (oil-loving or non-polar) groups of the surfactant. Commercial examples of nonionic surfactants useful in the present invention include but are not limited to nonylphenoxy or octylphenoxy poly(ethyleneoxy)ethanols available from Rhone-Poulenc as the IGEPAL CA or CO series, respectively; C₁₁-C₁₅ secondary-alcohol ethoxylates available from Union Carbide as the TERGITOL 15-S series; and polyoxyethylene sorbitan fatty acid esters available from ICI Chemicals as the TWEEN series of surfactants.

Useful cationic surfactants include alkylammonium salts having the formula CₙH₂ₙ₊₁N⁺(CH₃)₃ X⁻, where X is OH, Cl, Br, HSO₄ or a combination thereof, and where n is an integer from 8 to 22, and the formula C—H₂ₙ₊₁N⁺ (C₂H₅)₃ X⁻, where n is an integer from 12 to 18; gemini surfactants, for example those having the formula: [C₁₆H.₃₃N⁺(CH₃)₂CₘH₂ₘ₊₁] X⁻, wherein m is an integer from 2 to 12 and X is as defined above; aralkylammonium salts such as, for example, benzalkonium salts; and cetylethylpiperidinium salts, for example, C₁₆H₃₃N⁺(C₂H₅)(C₅H₁₀) X⁻, wherein X is as defined above.

Preferably, the emulsion polymerization of this invention is carried out in the presence of anionic surfactant(s). A useful range of surfactant concentration is from about 0.5 to about 8 weight percent, preferably from about 1 to about 5 weight percent, based on the total weight of solids, i.e all monomers of the monomer mixture, the hydrophobic stabilizer and the plasticizer of the oil phase of the emulsion pressure sensitive adhesive.

Desirably, the emulsion contains no chain transfer agents.

The adhesive latex prepared by an emulsion polymerization process. In emulsion polymerization a reaction occurs in micelles or emulsion microdrops suspended in aqueous medium. Any heat generated in the microdrops or micelles is quickly moderated by the effect of the heat capacity of the surrounding water phase.

The pressure sensitive adhesive lattices of the present invention are prepared by a batch, continuous or semi-continuous emulsion polymerization process. The polymerization generally comprises the steps of:

(a) providing an oil phase premix comprising

(i) the monomer mixture described supra;

(ii) the plasticizer; and

(iii) the hydrophobic stabilizer,

(b) combining said premix with a water phase comprising

(i) water,

(ii) a surfactant selected from the group consisting of anionic surfactants, nonionic surfactants, cationic surfactants, amphoteric surfactants, polymeric surfactants, and mixtures thereof,

(c) subjecting the mixture to high shear mixing condition to produce an emulsion having average droplet sizes of less than 50 μm, preferably less than 10 μm more preferable less than 1 μm;
(d) concurrently agitating and heating said emulsion to a temperature of about 30° C. to about 80° C., and permitting polymerization of said monomers in the oil-in-water emulsion until a polymeric latex is formed. It will be understood that other mixtures may be used. For example, the acid functional monomer, or other hydrophilic monomers, may be added to the aqueous solution. In addition, once the emulsion mixture is prepared, the monomers may partition between the oil phase and the water phase, according to their respective partition coefficients.

Alternatively, the monomer mixture can be polymerized in the absence of the tackifier, which is added after an initial polymerization step. The method comprising:
a) combining an oil phase comprising
100 parts by weight of a monomer mixture of:
80 to 99 parts by weight of a (meth)acrylate monomer
1 to 15 parts by weight of an acid-functional monomer
0 to 10 parts by weight of a non-acid functional polar monomer;
1 to 5 parts by weight of a multiacrylate crosslinker, and
optionally 1 to 10 parts by weight of a hydrophobic polymeric stabilizer
comprising a (meth)acrylate (co)polymer having a T_{g} greater 20° C.;
with
an aqueous phase comprising
a buffer, and
a nonpolymerizable surfactant,
b) mixing the two phases in the presence of an initiator, and heating to effect polymerization;
c) adding to the emulsion of step b):
20 to 50 parts by weight of a plasticizer, and
a) continue mixing.

The polymerizable emulsion further comprises an initiator, which may be an oil- or water soluble initiator. If oil-soluble, it is added to the oil phase premix. If water soluble, it is added to the emulsion after step (c) and prior to heating step (d). Water-soluble initiators are the preferred initiators. Examples of useful water soluble initiators include but are not limited to those selected from the group consisting of potassium persulfate, ammonium persulfate, sodium persulfate, and mixtures thereof. These water soluble initiators may be used in combination with reducing agents such as sodium bisulfite to constitute a redox initiator system. Examples of useful oil-soluble initiators include but are not limited to those selected from the group consisting of diazo compounds such as Vazo™ 64 (2,2′-azobis(isobutyronitrile), Vazo™ 52 (2,2′-azobis(2,4-dimethylpentanenitrile), both available from duPont, peroxides such as benzoyl peroxide and lauroyl peroxide, and mixtures thereof.

Desirable, the pH of the emulsion is 3-8, preferably 3-7, and may be adjusted by addition of an acid or base. The type and amount selected must not render the adhesive non-dispersible.

The acidity of the emulsion may be modified following latex formation using a pH modifier such as a basic solution, e.g., solutions of organic or inorganic acids or buffer solutions (e.g., sodium bicarbonate and the like), to the desired pH levels.

Silica nanoparticles, as nanosols may be incorporated into the acrylate adhesive by various methods. In one embodiment, an emulsion of the acrylate adhesive is added to the silica sol, followed by optional removal of the water and co-solvent (if used) via evaporation, thus leaving the silica nanoparticles dispersed in the acrylate adhesive. Alternatively, the silica sol may be added to an emulsion of the acrylate adhesive. It is preferred that the silica nanoparticles be blended under conditions of low shear to avoid precipitation of the acrylate emulsion. The evaporation step can be accomplished for example, via distillation, rotary evaporation or oven drying. Prior to drying, the emulsion generally does not exhibit pressure sensitive adhesive properties, so drying to less than 5 wt. % water, preferably less than 1 wt. % water, most preferably less than 0.5 wt. % is desirable. It will be understood that the water content of the adhesive may increase with time, as result of humidity.

It is preferable to coat the adhesive composition soon after preparation. It has been found that the viscosity of the composition increases with time, and this viscosity increase is believed to be due to agglomeration of the silica nanoparticles.

The resulting adhesives are self-wetting and removable. The adhesives exhibit great conformability permitting them to spontaneously wet out substrates. The surface characteristics also permit the adhesives to be bonded and removed from the substrate repeatedly for repositioning or reworking. The strong cohesive strength of the adhesives gives them structural integrity limiting cold flow and giving elevated temperature resistance in addition to permanent removability. In some embodiments the initial removability of an adhesive coated article bonded to a glass substrate, as measured by the 180° Peel Adhesion test described in the Examples section below, is no greater than 5 Newtons/decimeter. Upon aging for one week at room temperature the removability, as measured by the 180° Peel Adhesion test is no more than 10 Newtons/decimeter. In other embodiments, the removability after aging for at least one week at room temperature, as measured by the 180° Peel Adhesion is no more than 5 N/dm.

Adhesive articles may be prepared by coating the adhesive emulsion composition on a suitable support, such as a flexible backing Examples of materials that can be included in the flexible backing include polyolefins such as polyethylene, polypropylene (including isotactic polypropylene), polystyrene, polyester, polyvinyl alcohol, poly(ethylene terephthalate), poly(butylene terephthalate), poly(caprolactam), poly(vinylidene fluoride), polylactides, cellulose acetate, and ethyl cellulose and the like. Commercially available backing materials useful in the invention include kraft paper (available from Monadnock Paper, Inc.); cellophane (available from Flexel Corp.); and porous films obtained from poly(ethylene) and poly(propylene), such as Teslin™ (available from PPG Industries, Inc.), and Cellguard™ (available from Hoechst-Celanese).

The backing may also be formed of metal, metalized polymer films, or ceramic sheet materials may take the form of any article conventionally known to be utilized with pressure sensitive adhesive compositions such as labels, tapes, signs, covers, marking indicia, and the like.

The above-described compositions are coated on a substrate using conventional coating techniques modified as appropriate to the particular substrate. For example, these compositions can be applied to a variety of solid substrates by methods such as roller coating, flow coating, dip coating, spin coating, spray coating knife coating, and die coating. These various methods of coating allow the compositions to be placed on the substrate at variable thicknesses thus allowing a wider range of use of the compositions. Coating thicknesses may vary, but coating thicknesses of 2-500 microns (dry thickness), preferably about 10 to 250 microns, are contemplated.

The substrate is selected depending on the particular application in which it is to be used. For example, the adhesive can be applied to sheeting products, (e.g., decorative graphics and reflective products), label stock, and tape backings Additionally, the adhesive may be applied directly onto a substrate such as an automotive panel, or a glass window so that another substrate or object can be attached to the panel or window.

The adhesive can also be provided in the form of an adhesive transfer tape in which at least one layer of the adhesive is disposed on a release liner for application to a permanent substrate at a later time. The adhesive can also be provided as a single coated or double coated tape in which the adhesive is disposed on a permanent backing.

Exemplary adhesive articles in which the self wetting and removability features are especially important include, for example: large format articles such as graphic articles and protective films; and information display devices.

Large-format graphic articles or protective films typically include a thin polymeric film backed by an adhesive. These articles may be difficult to handle and apply onto a surface of a substrate. The large format article may be applied onto the surface of a substrate by what is sometimes called a “wet” application process. The wet application process involves spraying a liquid, typically a water/surfactant solution, onto the adhesive side of the large format article, and optionally onto the substrate surface. The liquid temporarily “detackifies” the adhesive so the installer may handle, slide, and re-position the large format article into a desired position on the substrate surface. The liquid also allows the installer to pull the large format article apart if it sticks to itself or prematurely adheres to the surface of the substrate. Applying a liquid to the adhesive may also improve the appearance of the installed large format article by providing a smooth, bubble free appearance with good adhesion build on the surface of the substrate.

Examples of a large format protective films include window films such as solar control films, shatter protection films, decoration films and the like. In some instances the film may be a multilayer film such as a multilayer IR film (i.e., an infrared reflecting film), such as a microlayer film having selective transmissivity such as an optically clear but infrared reflecting film as described in U.S. Pat. No. 5,360,659 (Arends et al.).

While the wet application process has been used successfully in many instances, it is a time consuming and messy process. A “dry” application process is generally desirable for installing large format graphic articles. Adhesives that are self wetting and removable may be applied with a dry installation process. The articles are easily attached to a large substrate because they are self wetting and yet they may be easily removed and repositioned as needed.

In other applications, such as information display devices, the wet application process cannot be used. Examples of information display devices include devices with a wide range of display area configurations including liquid crystal displays, plasma displays, front and rear projection displays, cathode ray tubes and signage. Such display area configurations can be employed in a variety of portable and non-portable information display devices including personal digital assistants, cell phones, touch-sensitive screens, wrist watches, car navigation systems, global positioning systems, depth finders, calculators, electronic books, CD or DVD players, projection television screens, computer monitors, notebook computer displays, instrument gauges, instrument panel covers, signage such as graphic displays (including indoor and outdoor graphics, bumper stickers, etc) reflective sheeting and the like.

A wide variety of information display devices are in use, both illuminated devices and non-illuminated devices. Many of these devices utilize adhesive articles, such as adhesive coated films, as part of their construction. One adhesive article frequently used in information display devices is a protective film. Such films are frequently used on information display devices that are frequently handled or have exposed viewing surfaces.

In some embodiments, the adhesives of this disclosure may be used to attach such films to information display devices because the adhesives have the properties of optical clarity, self wetting and removability. The adhesive property of optical clarity permits the information to be viewed through the adhesive without interference. The features of self wetting and removability permit the film to be easily applied to display surface, removed and reworked if needed during assembly and also removed and replaced during the working life of the information display device.

The articles of the disclosure may have a thickness greater than about 0.03 millimeters, generally a average birefringence (absolute) of less than 1×10⁻⁶, average light transmission greater than about 85% (over the spectral region of interest), preferably greater than 90%, more preferably greater than 95%, and a CIELAB b* less than about 1.5 units, preferably less than about 1.0 unit for samples with adhesive thickness of 500 microns. Further, the adhesive layer of these articles have optical properties at least equal to those of the composite article so the articles appear transparent. That is the adhesive per se also has these optical properties. The present disclosure provides optical articles comprising an optical film and a layer of the adhesive thereon.

Generally, the optical properties of the adhesive layer per se are measured indirectly by measuring the optical properties of the article (substrate coated with adhesive) and the substrate alone. The optical properties, such as transmissivity are generally reported as an average over the spectral region of interest; UV, visible and/or IR. Therefore, the adhesives of this disclosure have a birefringence (absolute) of less than 1×10⁻⁶, light transmission greater than about 85% (over the spectral region of interest), preferably greater than 90%, more preferably greater than 95%, and a CIELAB b* less than about 1.5 units, preferably less than about 1.0 unit, over the spectral regions of interest.

In some embodiments this disclosure provides solar control articles that may be applied to windows to selectively reduce the transmissivity over the spectral region of interest including UV, visible and IR. The solar control articles comprise a solar control film and a layer of the adhesive of this disclosure on a major surface thereof. Some known solar control films desirably have transmissivity on at least 85% in the visible range (400-700 nm), and reduced transmissivity of less than 80%, less that 70%, or less than 60% in the IR (700-2000 nm) and/or UV (100 to 400 nm) ranges.

Solar control films are known and include dyed or pigmented and vacuum-coated polymeric films reduce the transmissivity of various spectral regions from the incident light, i.e. sunlight. To reduce heat load from incident light, solar transmission is blocked in either the visible or the infrared portions of the solar spectrum (i.e., at wavelengths ranging from 400 nm to 2500 nm or greater.) Primarily through absorption, dyed films can control the transmission of visible light and consequently provides glare reduction. However, dyed films generally do not block near-infrared solar energy and consequently are not completely effective as other solar control films. Other known window films are fabricated using vacuum-deposited grey metals, such as stainless steel, inconel, monel, chrome, or nichrome alloys. The deposited grey metal films offer about the same degrees of transmission in the visible and infrared portions of the solar spectrum. The grey metal films are relatively stable when exposed to light, oxygen, and/or moisture, and in those cases in which the transmission of the coatings increases due to oxidation, color changes are generally not detectable. After application to clear glass, grey metals block light transmission by approximately equal amounts of solar reflection and absorption. Vacuum-deposited layers such as silver, aluminum, and copper control solar radiation primarily by reflection and are useful only in a limited number of applications due to the high level of visible reflectance. A modest degree of selectivity (i.e., higher visible transmission than infrared transmission) is afforded by certain reflective materials, such as copper and silver. The metal deposited films may also have air- and water-vapor barrier properties.

More recently, solar control films based on multilayer optical films (MLOF) have been developed which, in some embodiments, comprise hundreds or even thousands of film layers and optional nanoparticles, and which selectively transmit or reflect based on small differences in the refractive indices of adjacent film layers and reflectance or absorbance of the nanoparticles. The film layers have different refractive index characteristics so that some light is reflected at interfaces between adjacent layers. The layers are sufficiently thin so that light reflected at a plurality of the interfaces undergoes constructive or destructive interference in order to give the film the desired reflective or transmissive properties. For optical films designed to reflect light at ultraviolet, visible, or near-infrared wavelengths, each layer generally has an optical thickness (i.e., a physical thickness multiplied by refractive index) of less than about 1 micrometer. Thicker layers can, however, also be included, such as skin layers at the outer surfaces of the film, or protective boundary layers disposed within the film that separate packets of layers.

One such solar control multilayer film is described in US2006154049 (Weber et al., incorporated herein by reference) which describes a multilayer film article including an infrared light reflecting multilayer film having alternating layers of a first polymer type and a second polymer type, an infrared light absorbing nanoparticle layer including a plurality of metal oxide nanoparticles dispersed in a cured polymeric binder and having a thickness in a range from 1 to 20 micrometers. The nanoparticle layer being disposed adjacent the multilayer film. Another useful multilayer solar control film is described in U.S. Pat. No. 5,360,659 (Arends et al.) in which 50% of visible light between about 380-770 nm incident on the film is transmitted and at least 50% of infrared light of wavelengths of between about 770-2000 nm is reflected.

Other useful solar control films include those described in EP 355962 (Gilbert), U.S. Pat. No. 3,290,203 (Antonson et al.), U.S. Pat. No. 3,681,179 (Theissen), U.S. Pat. No. 4,095,013 (Burger), U.S. Pat. No. 6,565,992 (Ouderkirk et al.), U.S. Pat. No. 5,227,185 (Gobran), U.S. Pat. No. 4,329,396 (Arriban et al.), U.S. Pat. No. 7,368,161 (McGurran et al.), U.S. Pat. No. 6,811,867 (McGurran et al.), U.S. Pat. No. 7,906,202 (Padiyath et al.) and U.S. Pat. No. 6,040,061 (Bland et al.), incorporated herein by reference.

All parts, percentages, ratios, etc. used in the Examples are by weight unless indicated otherwise.

### Test Methods

### 180° Peel Adhesion Test

The 180° peel adhesion test was conducted on a slip/peel tester (obtained from Instrumentors Inc., Strongsville, Ohio, under the trade designation “iMass SP-2100 Peel/Slip Tester”). A test sample was prepared by placing a 0.5 inch (12.2 cm) wide by 7 inch (178 cm) long adhesive-coated tape on a 100 cm by 250 cm glass plate (the glass plate was previously cleaned by wiping with isopropyl alcohol). The adhesive-coated tape was rolled down onto the glass plate with two passes of a 2 kg roller. The adhesive-coated tape was removed from the plate at a peel angle of 180° and a platen speed of 90 inches per minute (2.3 meters per minute) for a total of 2 seconds, after aging on the glass plate. The aging periods were either 10 min at 23° C., 24 hours at 23° C., or 24 hours at 85° C. The force required to remove the adhesive-coated tape from the glass plate was measured in grams per 0.5 inch (1.3 cm) and converted to Newtons/decimeter (N/dm). Reported results were the average of three tests for each adhesive.

### Wet-Out Test

A glass slide with dimensions of 3 inches (7.6 cm)×1 inch (2.5 cm) was held at an angle of 69° with respect to a horizontal surface of self-wetting adhesive, and the glass slide was then was allowed to drop onto the horizontal surface of the self-wetting adhesive. The time required for the self-wetting adhesive to wet-out onto the glass slide was recorded in seconds and was then divided by the area wet-out (i.e., 3 inches² (19 cm²) for the glass slide). The test was performed three times for each sample, and the average test result was reported in seconds per square inch (s/in²), as well as the corresponding seconds per square centimeter (“s/cm²”).

### Materials

Table 1 lists materials used in the Examples. Water (H₂O) was distilled, deionized water.

TABLE 1

| Name | Description | Supplier |
|---|---|---|
| AA | acrylic acid (99%) | Alfa Aesar, |
| | | Heysham, England |
| ABP | 4-acryloyloxybenzophenone [CAS number | Prepared using a |
| | 22535-49-5] | method similar to |
| | | that |
| | | described in Temel |
| | | et al., Journal of |
| | | Photochemistry and |
| | | Photobiology A: |
| | | Chemistry, |
| | | 219, 26-31 (2011). |
| ACRONAL A220 | water-based adhesive, a latex having a | BASF Ludwishafen, |
| | solids content of 60%, pH of 7, and | Germany |
| | viscosity of 320 cP at 20 rpm and 240 cP at | |
| | 50 rpm | |
| ACRONAL A240 | water-based adhesive, a latex having a | BASF Ludwishafen, |
| | solids content of 51% and pH of 6 | Germany |
| DS-10 | sodium dodecyl benzene sulfoante | Rhodia, Brussels, |
| | | Belgium |
| EHA | 2-ethylhexyl acrylate | BASF Ludwishafen, |
| | | Germany |
| IboA | isobornyl acrylate | San Esters, New |
| | | York, NY |
| IOA | isooctyl acrylate | 3M Company, St. |
| | | Paul, MN |
| IOTG | isooctyl thioglycolate | Sigma Aldrich, St. |
| | | Louis, MO |
| IPM | isopropyl myristate | Lipo Chemicals, |
| | | Paterson, NJ |
| IRGACURE 651 | 2,2-dimethoxy-1,2-diphenyl-ethanone | BASF Ludwishafen, |
| | | Germany |
| IRGANOX 1010 | pentaerythritol tetrakis (3-(3,5-di-tert-butyl- | Ciba Specialty |
| | 4-hydroxyphenyl) propionate) | Chemicals |
| | | Incorporated, |
| | | Tarrytown, NY |
| KPS | potassium persulfate (99.9% purity) | Alfa Aesar, |
| | | Heysham, England |
| LUPERSOL 101 | 2,5-dimethyl-2,5-di(t-butylperoxy)hexane | Atofina, Carrollton, |
| | | KY |
| LUPERSOL 130 | 2,5-dimethyl-2,5-di(t-butylperoxy)-3- | Atofina, Carrollton, |
| | hexyne | KY |
| MEHQ | monomethyl ether hydroquinone [CAS No. | Sigma Aldrich, St. |
| | 150-76-5] | Louis, MO |
| Na₂S₂O₅ | sodium bisulfate (97% purity) | Alfa Aesar, |
| | | Heysham, England |
| NaHCO₃ | sodium bicarbonate (99.7%-100% purity) | EMD Chemical, |
| | | Inc., Gibbstown, NJ |
| NDM | 1-dodecanethiol (98% purity) | Alfa Aesar, |
| | | Heysham, England |
| PET backing | a clear polyester film obtained under the | Mitsubishi Polyester |
| | trade designation “HOSTAPHAN 3SAB” | Film, Greer, SC |
| POLYSTEP A-16- | sodium dodecylbenzene sulfonate (22% | Stepan, Northfield, |
| 22 | active material) | IL |
| PSA336 | a surfactant obtained under the trade | Air Products, |
| | designation “SURFYNOL PSA 336” | Allentown, PA |
| SFSD | sodium formaldehyde sulfoxylate dehydrate | Alfa Aesar, |
| | | Heysham, England |
| TBP | tert-butyl peroxide (70% aqueous solution) | Alfa Aesar, |
| | | Heysham, England |
| VAZO 52 | 2,2′-azobis(2,4-dimethylpentanenitrile) | DuPont, |
| | | Wilmington, DE |
| VAZO 67 | 2,2′-azobis(2-methylbutanenitrile) | DuPont, |
| | | Wilmington, DE |
| VAZO 88 | 1,1′-azobis(cyclohexanecarbonitrile) | DuPont, |
| | | Wilmington, DE |

### Preparative Example 1 (PE-1)

### Preparation of an Aqueous Dispersion of IPM Plasticizer

Firstly, 1 g of DS-10 (surfactant) was dissolved in 50 g of water by mixing with a magnetic stir bar. Then, 50 g of IPM (plasticizer) was slowly added into this surfactant aqueous solution, and the mixing was continued for another 10 minutes. The resulting milky solution was then transferred to a 1 L stainless steel WARING blender, and was homogenized at high speed setting for 2 minutes to make an aqueous dispersion of the IPM plasticizer.

### Comparative Example 1 (CE-1)

### A Latex Mixture not Including the Plasticizer of PE-1

Ingredients for the “aqueous phase” as listed in Table 2 were transferred to a reaction flask equipped with a stirrer, a reflux condenser, nitrogen inlet and a thermometer. Then, ingredients of the “oil phase” as listed in Table 2 were well mixed together and subsequently added into the reactor containing the aqueous phase. Thereafter, the reactants were heated with stirring under nitrogen to 60° C. At this point, the “first shot of initiator” as listed in Table 2 was added into the reactor, generating a reaction exotherm. After the exotherm peak, a mixture of the “second shot of initiator” ingredients as listed in Table 2 was added, and the polymerization reaction was continued for 1.5 hours at 70° C. A mixture of the “chaser” ingredients (TBP and SFSD) as listed in Table 2 was then added into the mixture of reactants, and the heating was continued for 2 hours to further improve the monomer conversion. The latex mixture was then cooled to room temperature, and filtered through cheese cloth. The filtered latex mixture had a solids content of about 47 wt. %, and a viscosity of 1500 centipoise (“cP”) at 20 revolutions per minute (“rpm”) and 830 cP at 50 rpm.

TABLE 2

| Component | Ingredients | Mass, grams |
|---|---|---|
| Aqueous Phase | DS-10 | 4.88 |
| | H₂O | 412.5 |
| | NaHCO₃ | 0.75 |
| Oil Phase | EHA | 367.5 |
| | AA | 7.5 |
| | NDM | 0.0375 |
| First shot of initiator | KPS | 0.375 |
| | H₂O | 6 |
| Second shot of initiator | KPS | 0.375 |
| | H₂O | 3 |
| Chaser: Oxidizer | TBP (70 wt. % solution) | 0.22 |
| | H₂O | 4 |
| Chaser: Reducer | SFSD | 0.1 |
| | H₂O | 4 |

### Example 1 (EX-1)

### Blending PE-1 and CE-1 Materials to Make a Water-Based Self-Wetting Adhesive

About 16.25 g of the above filtered latex mixture from CE-1 was added into a vial; then 3.84 g of the aqueous dispersion of IPM plasticizer from PE-1 was slowly added into the vial, with very gentle shaking of the vial. The resulting mixture was then coated on a PET backing to make hand spreads. The polymer to IPM plasticizer weight ratio was about 80/20 (in this and the following Examples, the “polymer to IPM plasticizer weight ratio” was according to what the weight ratio was designed to be).

### Comparative Example 2 (CE-2)

### Water-Based Adhesive for Example 2

The CE-2 material was commercially obtained water-based adhesive ACRONAL A220, which according to the manufacturer had a solids content of 60 wt. %, pH of 7, and a viscosity of 320 cP at 20 rpm and 240 cP at 50 rpm.

### Example 2 (EX-2)

About 40 g of ACRONAL A220 (CE-2, used as received) was put in a glass jar, and then 7 g of the aqueous dispersion of IPM plasticizer from PE-1 was slowly added into the jar while stirring the mixture with a magnetic stir bar. After this, the mixing was continued at 40° C. for 8 hours to swell the latex particle with the plasticizer. Finally, the adhesive mixture was cooled to room temperature, and then coated on a PET backing to make adhesive hand spreads. The polymer to IPM plasticizer weight ratio was about 77.5/22.5.

### Comparative Example 3 (CE-3)

### Water-Based Adhesive for Example 3

The CE-3 material was commercially obtained water-based adhesive ACRONAL A240, which according to the manufacturer had a solids content of 51 wt. % and a pH of 6.

### Example 3 (EX-3)

About 40 g of ACRONAL A240 (CE-3) was put in a glass jar, and then 7 g of the aqueous dispersion of IPM plasticizer from PE-1 was slowly added into the jar while stirring the mixture with a magnetic stir bar. After this, the mixing was continued at 40° C. for 8 hours to swell the latex particle with the plasticizer. The adhesive so obtained was then filtered, and then coated on a PET backing to make adhesive hand spreads. The polymer to IPM plasticizer ratio was about 74.5/25.5.

### Preparative Example 2 (PE-2)

### Preparation of a Pre-Formed Polymer for Example 4

The pre-formed polymer of PE-2 was prepared as follows. In a first polymerization step, a reactor was charged with 2 kg of a mixture consisting of 300 g IOA, 1600 g of IboA, and 100 g of AA (i.e., the ratio of IboA:IOA:AA was 15:80:5), 2 g of IRGANOX 1010, 50 g of chain transfer agent IOTG, 0.4 g of MEHQ, and 0.12 g of VAZO 52. The reactor was sealed and purged of oxygen (nitrogen purge), and then held at approximately 5 psig nitrogen pressure. The reaction mixture was heated to 60° C. and the reaction proceeded adiabatically and peaked at a temperature of 149° C. After the peak temperature was reached, the mixture was cooled to below 50° C.

To the reaction product of the first polymerization step was added 0.36 g of VAZO 52, 0.08 g of VAZO 67, 0.12 g of VAZO 88, 0.12 g of LUPERSOL 101, and 0.16 g of LUPERSOL 130 (the initiator components were added as a solution dissolved in ethyl acetate). Next, 25 g of chain transfer agent IOTG was added. The reactor was then sealed and purged of oxygen (nitrogen purge) and held at 5 psig nitrogen pressure. The reaction mixture was heated to 60° C. and the reaction proceeded adiabatically. After the reaction reached peak temperature of 120° C., the mixture was heated to 180° C. for 2 hours and drained while hot into aluminum trays. After cooling, the solid pre-formed polymer was hammered to flakes. Weight-averaged molecular weight of the pre-formed polymer of PE-2 was determined by gas phase chromatography to be about 7000.

### Example 4 (EX-4)

Ingredients of the aqueous phase as shown in Table 3 were well mixed together. Separately, the ingredients for the oil phase were also well mixed together until the pre-formed polymer of PE-2 was totally dissolved. The aqueous phase mixture and oil phase mixture were then mixed together well with a magnetic stir bar. The resulting mixture was transferred to a 1 L stainless steel WARING blender and homogenized at high speed setting to generate a stable pre-emulsion.

TABLE 3

| Component | Ingredients | Mass, grams |
|---|---|---|
| Aqueous Phase | DS-10 | 0.35 |
| | H₂O | 30.00 |
| | NaHCO₃ | 0.04 |
| Oil Phase | IPM | 5.80 |
| | Pre-formed Polymer of PE-2 | 0.73 |
| | EHA | 21.96 |
| | AA | 0.52 |
| | ABP | 0.04 |
| | NDM | 0.0034 |
| Initiator | KPS | 0.0405 |
| | H₂O | 1.00 |

The stable pre-emulsion was then transferred to a glass bottle. The initiator components listed in Table 3 were then were added to the bottle, followed by a nitrogen purge. The bottle was then well sealed and put into a water-bath orbital shaker (obtained from Sheldon Manufacture Inc., Cornelius, Oreg., under the trade designation “MODEL 1217”). The polymerization reaction was carried out for about 14 hours at a temperature of 60° C. and 180 rpm. The resulting latex was then cooled to room temperature, and filtered through cheese cloth, to provide the filtered latex of EX-4.

The filtered latex of EX-4 had a solids content of about 47 wt. %, and viscosity of 60 cP at 20 rpm and 54 cP at 50 rpm.

### Example 5 (EX-5)

About 53.31 g of the latex mixture of EX-4 was transferred to a glass jar, and 0.67 g of PSA336 as well as 1.29 g POLYSTEP A-16-22 were slowly added to the latex mixture of PE-3 under very gentle mixing. The resulting latex adhesive of EX-5 was filtered with cheese cloth, and then coated onto a PET backing. The adhesive polymer to plasticizer ratio was about 80/20.

### Preparative Example 3 (PE-3)

### Preparation of a Pre-Formed Polymer for Example 6

The pre-formed polymer of PE-3 was prepared by a bulk polymerization within a polymeric pouch, and the bulk polymerization was initiated by ultra-violet radiation, according to the method described in W09607522 and in U.S. Pat. No. 5,804,610 (Hamer, et al.). The monomers were IboA and AA, the photoinitiator used was IRGACURE 651, and IOTG was used as a chain transfer agent. The composition of the pre-polymer of PE-3 was as listed in Table 4 (“PHM”=“per hundred parts monomer”; “M_{w}”=weight average molecular weight; “T_{g}”=glass transition temperature).

TABLE 4

| | IboA, | AA, | IRGACURE 651, | IOTG, | M_{W}, | T_{g}, |
|---|---|---|---|---|---|---|
| Sample | PHM | PHM | PHM | PHM | g/mol | ° C. |
| PE-3 | 97 | 3 | 1 | 1 | 24,000 | 94 |

### Example 6 (EX-6)

Ingredients of the aqueous phase as shown in Table 5 were well mixed together. Separately, the ingredients for the oil phase were also well mixed together until the pre-formed polymer of PE-4 was totally dissolved. The aqueous phase mixture and oil phase mixture were then mixed together well with a magnetic stir bar. The resulting mixture was transferred to a 1 L stainless steel WARING blender and homogenized at high speed setting to generate a stable pre-emulsion.

TABLE 5

| Component | Ingredients | Mass, grams |
|---|---|---|
| Aqueous Phase | DS-10 | 0.73 |
| | H₂O | 60.05 |
| | NaHCO₃ | 0.04 |
| Oil Phase | IPM | 11.92 |
| | Pre-formed Polymer of PE-3 | 1.45 |
| | EHA | 44.31 |
| | AA | 1.16 |
| | ABP | 2.28 |
| | NDM | 0.7100 |
| Initiator | KPS | 0.0863 |
| | H₂O | 1.00 |

The stable pre-emulsion was then transferred to a glass bottle. The initiator components listed in Table 3 were then were added to the bottle, followed by a nitrogen purge. The bottle was then well sealed and put into a water-bath orbital shaker (obtained from Sheldon Manufacture Inc., Cornelius, Oreg., under the trade designation “MODEL 1217”). The polymerization reaction was carried out for about 14 hours at a temperature of 60° C. and 180 rpm. The resulting latex was then cooled to room temperature, and filtered through cheese cloth, to provide the latex mixture of EX-6.

The latex mixture of EX-6 had a solids content of about 48 wt. % and a viscosity of 60 cP at 50 rpm.

### Example 7 (EX-7)

About 53.31 g of the latex mixture of EX-6 was transferred to a glass jar, and 0.67 g of PSA336 surfactant as well as 1.29 g of POLYSTEP A-16-22 surfactant were slowly added to the latex mixture of PE-5 under very gentle mixing. The resulting latex mixture of EX-7 was filtered with cheese cloth and coated onto a PET backing. The polymer to plasticizer ratio was about 80/20.

### Comparative Example 4 (CE-4)

The latex of CE-4 was a comparative example for EX-4, EX-5, EX-6 and EX-7, but for EX-4 and EX-6 without an IPM plasticizer and EX-5 and EX-7 without IPM plasticizer and surfactant In addition, the latex of CE-4 was produced via regular emulsion polymerization method; while the latexes of EX-4, EX-5, EX-6 and EX-7 were made with high-shear mixing conditions.

First, the ingredients for the aqueous phase as listed in Table 6 were transferred to a reaction flask equipped with a stirrer, a reflux condenser, nitrogen inlet and a thermometer. Then the ingredients of the oil phase as listed in Table 6 were well mixed and added into the reactor. The combined reactants were then heated with stirring under nitrogen to 40° C. At this point, the first shot of initiator as listed in Table 6 was added into the reactor, and then heated to 50° C. After that, a reaction exotherm was generated. After the exotherm peak, the second shot of initiator was added, and the polymerization was continued for 1.5 hours at 70° C. Then the chaser ingredients as listed in Table 6 were added, and the reactant mixture was cooled to about 65° C. followed by a further heating for 1 hour at this temperature. The latex was then cooled to room temperature, and filtered with cheese cloth.

The resulting latex CE-4 had a solid content of about 45.5 wt. %, and a viscosity of 650 cP at 20 rpm and 470 cP at 50 rpm.

TABLE 6

| Component | Ingredients | Mass, grams |
|---|---|---|
| Aqueous Phase | DS-10 | 4.88 |
| | H₂O | 412.5 |
| | NaHCO₃ | 0.75 |
| Oil Phase | EHA | 367.5 |
| | AA | 7.5 |
| | NDM | 0.0375 |
| First shot of initiator | KPS | 0.375 |
| | Na₂S₂O₅ | 0.3 |
| | H₂O | 6 |
| Second shot of initiator | KPS | 0.375 |
| | H₂O | 3 |
| Chaser: Oxidizer | TBP (70 wt. % solution) | 0.18 |
| | H₂O | 2 |
| Chaser: Reducer | SFSD | 0.08 |
| | H₂O | 2 |

Test results for EX-1 to EX-4 and EX-6, as well as comparative examples 1 to 4 (CE-1 to CE-4) were as listed in Table 7 (“ND”=“not determined”). For the Wet-Out Test, results were measured in s/in² (the parenthetical “s/cm²” values were the calculated values by dividing the s/in² values by (2.54)² to obtain the corresponding s/cm² values). CE-4 was provided as a comparative example for both EX-4 and EX-6, having similar monomers but without IPM plasticizer.

TABLE 7

| | | | | Wet-Out |
|---|---|---|---|---|
| | 180° Peel Adhesion Test on glass, N/dm | | | Test, s/in² |
| Sample | 10 minutes | 1 day at 23° C. | 1 day at 85° C. | (s/cm²) |
| CE-1 | 10 | 19 | 25 | 17.7 (2.7) |
| EX-1 | 5 | 8 | 15 | 7 (1.1) |
| CE-2 | 2.34 | 2.48 | 5.08 | 26 (4.0) |
| EX-2 | 0.34 | 0.57 | 1.66 | 6.2 (1.0) |
| CE-3 | 2.31 | 2.87 | 4.98 | 41.6 (6.4) |
| EX-3 | 0.73 | 1.57 | 3.33 | 12.2 (1.9) |
| CE-4 | 1.15 | 1.27 | 1.4 | 20.6 (3.2) |
| EX-5 | 2.86 | 2.82 | 4.16 | 14.1 (2.2) |
| EX-7 | ND | ND | ND | 11.4 (1.8) |

This disclosure provides the following illustrative embodiments.
1. A polymerizable emulsion comprising:

a) a discontinuous oil phase comprising:
i. 100 parts by weight of a monomer mixture of
   a) 80 to 99 parts by weight of a (meth)acrylate monomer
   b) 1 to 10 parts by weight of an acid-functional polar monomer
   c) 0 to 10 parts by weight of a non-acid functional polar monomer;
   d) 0 to 1 parts by weight of a multiacrylate crosslinker,
ii. 20 to 50 parts by weight of a plasticizer
iii. 1 to 10 parts by weight of a hydrophobic polymeric stabilizer comprising a (meth)acrylate (co)polymer having a T_{g} greater 20° C.;

b) a continuous aqueous phase comprising
i. a buffer
ii. a nonpolymerizable surfactant,

c) an initiator.
2. The polymerizable emulsion of embodiment 1 wherein the hydrophobic polymeric stabilizer is a (meth)acrylate copolymer.
3. The polymerizable emulsion of embodiment 2 wherein the hydrophobic polymeric stabilizer comprises:

90-99 wt. % (meth)acrylate esters,

0-5 wt. % acid functional monomers and

0-5 wt. % other non-acid-functional polar monomers.
4. The polymerizable emulsion of embodiment 3 wherein the total of the acid functional monomers and non-acid-functional polar monomers is 5 wt. % of less.
5. The polymerizable emulsion of any of the previous embodiments wherein the plasticizer is selected from esters of mono- or di-basic acids
6. The polymerizable emulsion of any of the previous embodiments comprising 50 to 75 weight % of said oil phase and 25 to 50 weight % of said aqueous phase.
7. The polymerizable emulsion of any of the previous embodiments wherein the average droplet size of the oil phase is less than 50 μm, preferably less than 10 μm more preferable less than 1 μm.
8. The polymerizable emulsion of any of the previous embodiments wherein the oil phase premix contains an oil-soluble initiator.
9. The polymerizable emulsion of any of the previous embodiments wherein the aqueous phase premix contains a water-soluble initiator.
10. The polymerizable emulsion of any of the previous embodiments containing no chain transfer agents.
11. A latex adhesive comprising the polymerized emulsion composition of any of the previous embodiments.
12. A method of preparing a latex adhesive comprising:
   a) Combining an oil phase comprising
   100 parts by weight of a monomer mixture of:
   80 to 99 parts by weight of a (meth)acrylate monomer
   1 to 15 parts by weight of an acid-functional monomer
   0 to 10 parts by weight of a non-acid functional polar monomer;
   20 to 5 parts by weight of a multiacrylate crosslinker, and
   20 to 50 parts by weight of a plasticizer, and
   1 to 10 parts by weight of a hydrophobic polymeric stabilizer comprising a (meth)acrylate (co)polymer having a T_{g} greater 20° C.;
   with
   an aqueous phase comprising
   a buffer, and
   a nonpolymerizable surfactant,
   b) mixing the two phases under high shear conditions to produce an emulsion having an average oil droplet size of <50 μm, in the presence of an initiator, and heating to effect polymerization.
13. The method of embodiment 12 further comprising the step of coating the polymerized emulsion on a substrate.
14. An adhesive article comprising a substrate and a coating of the cured adhesive of any of embodiments 1-11 on a surface thereof
15. The adhesive article of embodiment 14 wherein the adhesive has a 180° peel value of ≦5 Newtons/decimeter.
16. The adhesive article of embodiment 14 wherein the substrate is transparent.
17. The adhesive article of embodiment 14 wherein the adhesive has a transmissivity of greater than 90% in the visible range.
18. The adhesive article of embodiment 14 wherein the substrate is a solar control film.
19. The adhesive article of embodiment 14 having a transmissivity of at least 80% in the visible range.
20. The adhesive article of embodiment 14 wherein the film is a multilayer optical film.
21. The adhesive article of embodiment 14 wherein the article is a protective film for information display devices.
22. A method of preparing a latex adhesive comprising:
   a) combining an oil phase comprising
   100 parts by weight of a monomer mixture of:
   80 to 99 parts by weight of a (meth)acrylate monomer
   1 to 10 parts by weight of an acid-functional monomer
   0 to 10 parts by weight of a non-acid functional polar monomer;
   0 to 1 parts by weight of a multiacrylate crosslinker, and
   optionally 1 to 10 parts by weight of a hydrophobic polymeric stabilizer
   comprising a (meth)acrylate (co)polymer having a T_{g} greater 20° C.;
   with
   an aqueous phase comprising
   a buffer, and
   a nonpolymerizable surfactant,
   b) mixing the two phases in the presence of an initiator, and heating to effect polymerization;
   c) adding to the emulsion of step b):
   20 to 50 parts by weight of a plasticizer, and
   d) continue mixing.
23. The method of embodiment 22 where step b) of mixing is under high shear conditions to produce an emulsion having an average oil droplet size of <50 μm.

1. A polymerizable emulsion comprising:
a) a discontinuous oil phase comprising:
i. 100 parts by weight of a monomer mixture of
a) 80 to 99 parts by weight of a (meth)acrylate monomer
b) 1 to 10 parts by weight of an acid-functional polar monomer
c) 0 to 10 parts by weight of a non-acid functional polar monomer;
d) 0 to 1 parts by weight of a multiacrylate crosslinker,
ii. 20 to 50 parts by weight of a plasticizer
iii. 1 to 10 parts by weight of a hydrophobic polymeric stabilizer comprising a (meth)acrylate (co)polymer having a T_{g} greater 20° C. as calculated using the Fox Equation;
a) a continuous aqueous phase comprising
i. a buffer
ii. a nonpolymerizable surfactant,
b) an initiator.

2. (canceled)

3. The polymerizable emulsion of claim 1 wherein the hydrophobic polymeric stabilizer comprises:
90-99 wt. % (meth)acrylate esters,
0-5 wt. % acid functional monomers and
0-5 wt. % other non-acid-functional polar monomers.

4. The polymerizable emulsion of claim 1 wherein the total of the acid functional monomers and non-acid-functional polar monomers is 5 wt. % of less.

5. The polymerizable emulsion of claim 1 wherein the plasticizer is selected from esters of mono- or di-basic acids.

6. The polymerizable emulsion of claim 1 comprising 50 to 75 weight % of said oil phase and 25 to 50 weight % of said aqueous phase.

7-9. (canceled)

10. The polymerizable emulsion of claim 1 containing no chain transfer agents.

11. A latex adhesive comprising the polymerized emulsion composition of claim 1.

12. A method of preparing a latex adhesive comprising:
a) Combining an oil phase comprising
100 parts by weight of a monomer mixture of:
80 to 99 parts by weight of a (meth)acrylate monomer
1 to 15 parts by weight of an acid-functional monomer
0 to 10 parts by weight of a non-acid functional polar monomer;
20 to 5 parts by weight of a multiacrylate crosslinker, and
20 to 50 parts by weight of a plasticizer, and
1 to 10 parts by weight of a hydrophobic polymeric stabilizer comprising a (meth)acrylate (co)polymer having a T_{g} greater 20° C.;
with
an aqueous phase comprising
a buffer, and
a nonpolymerizable surfactant,
b) mixing the two phases under high shear conditions to produce an emulsion having an average oil droplet size of <50 μm, in the presence of an initiator, and heating to effect polymerization.

13. The method of claim 12 further comprising the step of coating the polymerized emulsion on a substrate.

14. An adhesive article comprising a substrate and a coating of the cured adhesive of on a surface thereof.

15. The adhesive article of claim 14 wherein the adhesive has a 180° peel value of ≦5 Newtons/decimeter.

16. The adhesive article of claim 14 wherein the substrate is transparent.

17. (canceled)

18. The adhesive article of claim 14 wherein the substrate is a solar control film.

19. The adhesive article of claim 14 having a transmissivity of at least 80% in the visible range.

20. The adhesive article of claim 14 wherein the film is a multilayer optical film.

21. The adhesive article of claim 14 wherein the article is a protective film for information display devices.

22. A method of preparing a latex adhesive comprising:
a) combining an oil phase comprising
100 parts by weight of a monomer mixture of:
80 to 99 parts by weight of a (meth)acrylate monomer
1 to 10 parts by weight of an acid-functional monomer
0 to 10 parts by weight of a non-acid functional polar monomer;
0 to 1 parts by weight of a multiacrylate crosslinker, and
optionally 1 to 10 parts by weight of a hydrophobic polymeric stabilizer comprising a (meth)acrylate (co)polymer having a T_{g} greater 20° C.;
with
an aqueous phase comprising
a buffer, and
a nonpolymerizable surfactant,
b) mixing the two phases in the presence of an initiator, and heating to effect polymerization;
c) adding to the emulsion of step b):
20 to 50 parts by weight of a plasticizer, and
c) continue mixing.

23. The method of claim 22 where step b) of mixing is under high shear conditions to produce an emulsion having an average oil droplet size of <50 μm.
